(19) United States
(12) Patent Application Publication
(10) Pub. No.: US 2019/0339558 A1
(43) Pub. Date: Nov. 7, 2019

(54) Methods and Apparatuses for Copying a Diversity of Hologram Prescriptions from a Common Master

(71) Applicant: DigiLens Inc., Sunnyvale, CA (US)

(72) Inventors: Jonathan David Waldern, Los Altos Hills, CA (US); Alastair John Grant, San Jose, CA (US); Milan Momcilo Popovich, Leicester (GB)

(73) Assignee: DigiLens Inc., Sunnyvale, CA (US)

(21) Appl. No.: 16/405,721

(22) Filed: May 7, 2019

Related U.S. Application Data
(60) Provisional application No. 62/667,891, filed on May 7, 2018.

(51) Int. Cl. G02F 1/1334; G02F 1/1347; G03H 1/02

(52) U.S. Cl. CPC G02F 1/13342; G02F 1/1347; G03H 2001/026; G02F 2001/13478; G03H 1/0276

(57) ABSTRACT

Systems and methods for copying a diversity of hologram prescriptions from a common master in accordance with various embodiments of the invention are illustrated. One embodiment includes a method of contact copying a hologram from a master. The method includes steps for providing a light source, a master grating encoding a first grating prescription, a substrate supporting a layer of holographic recording material, and a wavefront modifying component, forming a first wavefront from the light source, reflecting the first wavefront from the wavefront modifying component to provide a second wavefront, diffracting the second wavefront to provide diffracted light with a third wavefront and zero-order light with the second wavefront, interfering the third wavefront and the zero-order light at a contact image plane, and forming a hologram having a second grating prescription different from the first grating prescription.

### CROSS-REFERENCE TO RELATED APPLICATIONS

The current application claims the benefit of and priority under 35 U.S.C. § 119(e) to U.S. Provisional Patent Application No. 62/667,891 entitled “Method and Apparatus for Copying a Diversity of Hologram Prescriptions from a Common Master,” filed May 7, 2018. The disclosure of U.S. Provisional Patent Application No. 62/667,891 is hereby incorporated by reference in its entirety for all purposes.

### FIELD OF THE INVENTION

The present invention generally relates to methods for the manufacturing of displays and, more specifically, for the manufacturing of waveguide displays.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (“TIR”).

Fabrication of waveguides can include the use of material systems that allow for the recording of holographic optical elements within the waveguides. One class of such material includes polymer dispersed liquid crystal (“PDLC”) mixtures, which are mixtures containing photopolymerizable monomers and liquid crystals. A further subclass of such mixtures includes holographic polymer dispersed liquid crystal (“HPDLC”) mixtures. Holographic optical elements, such as volume phase gratings, can be recorded in such a liquid mixture by illuminating the material with two mutually coherent laser beams. During the recording process, the monomers polymerize and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (“AR”) and virtual reality (“VR”), compact heads-up displays (“HUDs”) for aviation and road transport, and sensors for biometric and laser radar (“LIDAR”) applications.

### SUMMARY OF THE INVENTION

Systems and methods for copying a diversity of hologram prescriptions from a common master in accordance with various embodiments of the invention are illustrated. One embodiment includes a method of contact copying a hologram from a master. The method includes steps for providing a light source, a master grating encoding a first grating prescription, a substrate supporting a layer of holographic recording material, and a wavefront modifying component, forming a first wavefront from the light source, reflecting the first wavefront from the wavefront modifying component to provide a second wavefront, diffracting the second wavefront to provide diffracted light with a third wavefront and zero-order light with the second wavefront, interfering the third wavefront and the zero-order light at a contact image plane, and forming a hologram having a second grating prescription different from the first grating prescription.

In a further embodiment, the method further includes steps for providing a transparent spacer sandwiched by the substrate and the master grating.

In still another embodiment, the wavefront modifying component includes an element that is at least one of a reflective freeform optical surface, a transmissive freeform optical surface, a freeform optical element, an adaptive optical element, and a dynamically reconfigurable freeform optical surface.

In a still further embodiment, the master grating is an amplitude grating or a volume grating.

In yet another embodiment, the substrate has dimensions of at least 300 mm. by 500 mm.

In a yet further embodiment, the method further includes steps for providing a wavefront sensor, measuring the third wavefront, and providing an output signal for controlling the wavefront modifying component.

In another additional embodiment, the method further includes steps for forming a multiplexed hologram.

In a further additional embodiment, the holographic recording material is a liquid crystal and monomer mixture.

In another embodiment again, the substrate is curved and the wavefront modifying component compensates for an aberration produced by optical propagation through a curved holographic waveguide.

In a further embodiment again, the wavefront modifying component is configured to compensate for a defect in the master grating.

A still yet another embodiment includes an apparatus for contact copying a hologram from a master, the apparatus including a light source, a master grating, a substrate supporting a layer of holographic recording material, and a wavefront modifying component for modifying a wavefront from the light source disposed between the light source and the master grating.

In a still yet further embodiment, the apparatus further includes a transparent spacer sandwiched by the substrate and the master grating.

In still another additional embodiment, the wavefront modifying component includes an element that is at least one of a reflective freeform optical surface, a transmissive freeform optical surface, a freeform optical element, an adaptive optical element, and a dynamically reconfigurable freeform optical surface.

In a still further additional embodiment, the master grating is an amplitude grating or a volume grating.

In still another embodiment again, the substrate has dimensions of at least 300 mm. by 500 mm.

In a still further embodiment again, the apparatus further includes a wavefront sensor.

In yet another additional embodiment, the wavefront sensor provides an output signal for controlling the wavefront modifying component.

In a yet further additional embodiment, the holographic recording material is a liquid crystal and monomer mixture.

In yet another embodiment again, the substrate is curved and the wavefront modifying component compensates for an aberration produced by optical propagation through a curved holographic waveguide.

In a yet further embodiment again, the wavefront modifying component is configured to compensate for a defect in the master grating.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as exemplary embodiments of the invention and should not be construed as a complete recitation of the scope of the invention. It will apparent to those skilled in the art that the present invention may be practiced with some or all of the present invention as disclosed in the following description.

FIG. 1 conceptually illustrates a holographic recording system utilizing a reflector having a freeform reflective surface in accordance with an embodiment of the invention.

FIG. 2 conceptually illustrates a holographic recording system utilizing a reflector having a freeform reflective surface and an adaptive optical element in accordance with an embodiment of the invention.

FIG. 3 conceptually illustrates a recording system with a wavefront sensor in accordance with an embodiment of the invention.

FIG. 4 conceptually illustrates a recording system for recording a grating into a curved substrate in accordance with an embodiment of the invention.

FIG. 5 is a flow chart conceptually illustrating a method of contact copying a hologram from a master in accordance with an embodiment of the invention.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings are not drawn to scale unless stated otherwise.

Traditionally, cost-effective processes for fabricating holographic waveguides include techniques based on contact copying from a master. For waveguides with the demanding prescriptions required for wide field-of-view, uniform illumination, and high resolution, the fabrication of masters for each new application configuration can be prohibitively expensive. This is particularly problematic in the case of a car HUD (AutoHUD), which reflects image light from the waveguide off the windshield into the driver's eyebox. In such applications, the waveguide gratings can be corrected for the wavefront distortion resulting from the windshield curvature. Such corrections can be different for each type of windshield, presenting a significant manufacturing barrier to a universal HUD solution. As such, many embodiments of the invention are directed toward methods and apparatuses for wavefront compensation to fabricate a hologram prescription that is different from a master. In many embodiments, wavefront compensation can be used to fabricate a diversity of hologram prescriptions from a common master. In a number of embodiments, the wavefront shape can be monitored during fabrication, and the necessary compensation can be applied to the hologram recording wavefronts. Such techniques in accordance with various embodiments of the invention can also be used to overcome the effects of errors in a master, allowing for the fabrication of a desired hologram prescription without having to fabricate a new master having the desired prescription.

Referring generally to the drawings, methods and systems for recording holographic elements and optical structures in accordance with various embodiments of the invention are illustrated. In many embodiments, such methods and systems are implemented in holographic waveguide manufacturing processes. Recording holographic elements, such as but not limited to holographic gratings, within waveguides can be accomplished through a variety of different techniques. The photosensitive material can be exposed with an interference pattern formed by two light beams formed from one or more light sources in order to fabricate a grating that correlates with the interference pattern within the waveguide. In a number of embodiments, the source has a high degree of spatial and temporal coherence and can include one or more lasers. In some embodiments, the interferometric recording process includes the application of other stimuli (e.g. electromagnetic radiation of wavelengths different from those used to form the interfere patterns, magnetic fields, thermal stimuli, and mechanical forces) with the aim of controlling the grating formation processes to improve the quality of the recorded gratings, as measured by the index modulation, polarization characteristics, and contrast of the final gratings. In several embodiments, the recording system uses a single light beam, which can simplify the alignment of the various components within the recording system and can reduce wave front error found in dual light beam systems caused by the different paths of the two light beams. Such systems can utilize a master grating in conjunction with the single light source. When the light interacts with the master grating during operation, the first order diffraction and the zero order beam can overlap to create an interference pattern, which can then expose the optical recording material to form the desired grating. The characteristics of the grating can depend heavily on the master grating. In a number of embodiments, the formed grating is a copy of the master grating.

Depending on the desired characteristics of the grating to be formed, the master grating can be formed accordingly. However, fabricating such master gratings can be prohibitively expensive in some applications, such as those described above. Recording processes and systems in accordance with various embodiments of the invention can allow for the fabrication of many different gratings utilizing only a single master grating. In such embodiments, the recording system can include a master grating, a light source, a reflector having a freeform reflective surface, a layer of holographic recording material sandwiched by transparent substrates forming a cell. In further embodiments, the system includes a spacer in contact with the master grating and the cell. The light source can emit a beam that, once reflected by the freeform reflective surface, forms a modified wavefront. The modified wavefront can interact with the master, which diffracts the beam into first order diffracted ray paths and zero-order non-diffracted ray paths. The diffracted light can interfere with the zero-order light to form an interference pattern in the holographic recording material layer. Accordingly, the interference pattern can have spatial frequency characteristics that differ from those of the master grating. Descriptions of such systems and their modifications along with waveguide gratings structures and materials are discussed below in further detail.

### Switchable Bragg Gratings

Optical structures recorded in waveguides can include many different types of optical elements, such as but not limited to diffraction gratings. In many embodiments, the grating implemented is a Bragg grating (also referred to as a volume grating). Bragg gratings can have high efficiency with little light being diffracted into higher orders. The relative amount of light in the diffracted and zero order can be varied by controlling the refractive index modulation of the grating, a property that is can be used to make lossy waveguide gratings for extracting light over a large pupil. One class of gratings used in holographic waveguide devices is the Switchable Bragg Grating (“SBG”). SBGs can be fabricated by first placing a thin film of a mixture of photopolymerizable monomers and liquid crystal material between glass plates or substrates. In many cases, the glass plates are in a parallel configuration. One or both glass plates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, component volume fractions of the materials in the mixture, and exposure temperature can determine the resulting grating morphology and performance. As can readily be appreciated, a wide variety of materials and mixtures can be used depending on the specific requirements of a given application. In many embodiments, HPDLC material is used. During the recording process, the monomers polymerize and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to very low levels. Typically, the electrodes are configured such that the applied electric field will be perpendicular to the substrates. In a number of embodiments, the electrodes are fabricated from indium tin oxide (“ITO”). In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Typically, the SBG elements are switched clear in 30 ps with a longer relaxation time to switch ON. Note that the diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The glass plates used to form the HPDLC cell provide a total internal reflection (“TIR”) light guiding structure. Light can be coupled out of the SBG when the switchable grating diffracts the light at an angle beyond the TIR condition.

One of the known attributes of transmission SBGs is that the LC molecules tend to align with an average direction normal to the grating fringe planes (i.e., parallel to the grating or K-vector). The effect of the LC molecule alignment is that transmission SBGs efficiently diffract P polarized light (i.e., light with a polarization vector in the plane of incidence), but have nearly zero diffraction efficiency for S polarized light (i.e., light with the polarization vector normal to the plane of incidence). As a result, transmission SBGs typically cannot be used at near-grazing incidence as the diffraction efficiency of any grating for P polarization falls to zero when the included angle between the incident and reflected light is small. In addition, illumination light with non-matched polarization is not captured efficiently in holographic displays sensitive to one polarization only.

### HPDLC Material Systems

HPDLC mixtures in accordance with various embodiments of the invention generally include LC, monomers, photoinitiator dyes, and coinitiators. The mixture (often referred to as syrup) frequently also includes a surfactant. For the purposes of describing the invention, a surfactant is defined as any chemical agent that lowers the surface tension of the total liquid mixture. The use of surfactants in HPDLC mixtures is known and dates back to the earliest investigations of HPDLCs. For example, a paper by R. L Sutherland et al., SPIE Vol. 2689, 158-169, 1996, the disclosure of which is incorporated herein by reference, describes an HPDLC mixture including a monomer, photoinitiator, coinitiator, chain extender, and LCs to which a surfactant can be added. Surfactants are also mentioned in a paper by Natarajan et al, Journal of Nonlinear Optical Physics and Materials, Vol. 5 No. I 89-98, 1996, the disclosure of which is incorporated herein by reference. Furthermore, U.S. Pat. No. 7,018,563 by Sutherland; et al., discusses polymer-dispersed liquid crystal material for forming a polymer-dispersed liquid crystal optical element comprising: at least one acrylic acid monomer; at least one type of liquid crystal material; a photoinitiator dye; a coinitiator; and a surfactant. The disclosure of U.S. Pat. No. 7,018,563 is hereby incorporated by reference in its entirety.

The patent and scientific literature contains many examples of material systems and processes that can be used to fabricate SBGs, including investigations into formulating such material systems for achieving high diffraction efficiency, fast response time, low drive voltage, and so forth. U.S. Pat. No. 5,942,157 by Sutherland, and U.S. Pat. No. 5,751,452 by Tanaka et al. both describe monomer and liquid crystal material combinations suitable for fabricating SBG devices. Examples of recipes can also be found in papers dating back to the early 1990s. Many of these materials use acrylate monomers, including:
R. L. Sutherland et al., Chem. Mater. 5, 1533 (1993), the disclosure of which is incorporated herein by reference, describes the use of acrylate polymers and surfactants. Specifically, the recipe comprises a crosslinking multifunctional acrylate monomer; a chain extender N-vinyl pyrrolidinone, LC E7, photo-initiator rose Bengal, and coinitiator N-phenyl glycine. Surfactant octanoic acid was added in certain variants.
Fontecchio et al., SID 00 Digest 774-776, 2000, the disclosure of which is incorporated herein by reference, describes a UV curable HPDLC for reflective display applications including a multi-functional acrylate monomer, LC, a photoinitiator, a coinitiators, and a chain terminator.
Y. H. Cho, et al., Polymer International, 48, 1085-1090, 1999, the disclosure of which is incorporated herein by reference, discloses HPDLC recipes including acrylates.
Karasawa et al., Japanese Journal of Applied Physics, Vol. 36, 6388-6392, 1997, the disclosure of which is incorporated herein by reference, describes acrylates of various functional orders.
T. J. Bunning et al., Polymer Science: Part B: Polymer Physics, Vol. 35, 2825-2833, 1997, the disclosure of which is incorporated herein by reference, also describes multifunctional acrylate monomers.
G. S. Iannacchione et al., Europhysics Letters Vol. 36 (6). 425-430, 1996, the disclosure of which is incorporated herein by reference, describes a PDLC mixture including a penta-acrylate monomer, LC, chain extender, coinitiators, and photoinitiator.

Acrylates offer the benefits of fast kinetics, good mixing with other materials, and compatibility with film forming processes. Since acrylates are cross-linked, they tend to be mechanically robust and flexible. For example, urethane acrylates of functionality 2 (di) and 3 (tri) have been used extensively for HPDLC technology. Higher functionality materials such as penta and hex functional stems have also been used.

### Waveguide Exposure Processes and Mastering Systems

Volume gratings can be recorded in a waveguide cell using many different methods in accordance with various embodiments of the invention. The recording of optical elements in optical recording materials can be achieved using any number and type of electromagnetic radiation sources. Depending on the application, the exposure source(s) and/or recording system can be configured to record optical elements using varying levels of exposure power and duration. As discussed above with regards to SBGs, techniques for recording volume gratings can include the exposure of an optical recording material using two mutually coherent laser beams, where the superimposition of the two beams create a periodic intensity distribution along the interference pattern. The optical recording material can form grating structures exhibiting a refractive index modulation pattern matching the periodic intensity distribution. In HPDLC mixtures, the light intensity distribution results in diffusion and polymerization of monomers into the high intensity regions and simultaneous diffusion of liquid crystal into the dark regions. This phase separation creates alternating liquid crystal-rich and liquid crystal-depleted regions that form the fringe planes of the grating. The grating structures can be formed with slanted or non-slanted fringes depending on how the recording beams are configured.

Another method for recording volume gratings in an optical recording material includes the use of a single beam to form an interference pattern onto the optical recording material. This can be achieved through the use of a master grating. In many embodiments, the master grating is a volume grating. In some embodiments, the master grating is an amplitude grating. Upon interaction with the master grating, the single beam can diffract. The first order diffraction and the zero order beam can overlap to create an interference pattern, which can then expose the optical recording material to form the desired volume grating.

In addition to the exposure schemes for the recording of transmission and reflection waveguides, many mastering techniques can be used to perform such recordings and to form various waveguide structures and gratings. In various embodiments, the mastering system includes the use of an amplitude grating (“AG”). Such gratings can be used to form various types of gratings with different configurations. In many embodiments, an amplitude master grating is used to form a rolled K-vector (RKV) grating within a waveguide. In further embodiments, the amplitude grating contains a linear variation in the grating period, called a chirp. Chirped gratings can be utilized in many different ways. Some processes include directing a zero-order input beam toward a chirped amplitude grating to create a diffraction profile with a linear variation.

In many embodiments, a single beam exposure system is implemented to include the use of a single beam in a near to contact copy mode, which can be considered a hybrid between a direct contact copy and a separate two-beam contact copy—i.e., a hybrid contact copy. This approach can be useful where it is not possible to make a direct contact copy, such as where the separation distance from the master plane to the exposure plane is not negligible. In such circumstances, the separation distance can be critical. For example, in the exposure process for an RKV grating, the separation distance can be important and should be accounted for in order to preserve the surface projected fringe period across the full RKV grating (without which full waveguide path reciprocity cannot be maintained). In several embodiments, a single plane wavefront input beam can be configured to interact with a cylindrical lens to provide 1D focus. In further embodiments, at least a portion of the light can generate a diffractive beam through interaction with a chirped master, and another portion can pass through (with attenuation) as zero order, preserving the original 1D focus function of the cylindrical lens.

In many embodiments, a master can be designed to incorporate more than one amplitude grating. By incorporating multiple amplitude gratings in a single master, alignment errors can be reduced compared to systems utilizing a single master for each grating. In some embodiments, the mastering system includes a master with three amplitude gratings. In several embodiments, the master can be developed to incorporate the RKV functionality in the simultaneous exposure of three patterns written in one plate. The input and/or output master gratings can be chirped gratings, with additional gratings as needed in zero order regions where there is no overlap with the chip.

In many embodiments, mastering multiple grating elements within a waveguide structure can involve the use of multiple exposures. In such embodiments, a multi-step process can be used wherein different regions corresponding to different grating elements of the contact copy element are exposed. In many such embodiments, the process can include sequentially exposing the contact copy. For example, the process can include first exposing an output grating region (e.g., using a large area O/P only master or part of a multi-grating master) and then multiple exposures to form the fold grating region.

Masters incorporating more than one amplitude grating can also be utilized for the simultaneous exposure of more than one grating. In such systems, a collimated or coherent incident light beam can be brought into focus via optics through a master AG and onto the desired regions of the contact copy through a suitable transparent substrate material. In many embodiments, a 3:1 mastering process can be utilized to fabricate a holographic waveguide having input, fold and output gratings in a single exposure. In a variety of such embodiments, the input, fold, and/or output gratings are RKV gratings. In a number of embodiments, the fold grating may be segmented into multiple zones. Although any number of zones can be utilized in accordance with the requirements of specific applications, in some embodiments of the invention the fold grating may be divided into 5 segments.

Although specific configurations of exposure systems are discussed, it will be understood that various modifications including the number and type of gratings to be formed can change depending on the specific requirements of a given application. Similarly, any number and arrangement of illumination beams can be provided in such systems. The exposure systems can further include any suitable optical frames, movable adapters, exposure plates, etc. required to allow for the fixation of optical elements relative to the master and contact copy regions. As previously described, the holographic waveguides implemented in association with the mastering and fabrication embodiments can be a single piece and/or as a stack of waveguides in accordance with the requirements of specific applications of embodiments of the invention. For example, a holographic waveguide can include three layers, one for each of red, blue, and green.

In the typical RKV grating, the grating vector rolls in the same plane as the incident plane of the construction beams. In the fold grating, the grating vector can roll perpendicular to the incident plane of the construction beams. Many embodiments include a stepped fold RKV, where the angle in each section changes orthogonally to the K-vector direction. Several embodiments include scanned RKV fold gratings, where a scanned beam exposes the RKV with a different angle in discrete steps across the aperture of the plane fold master grating to generate a stepped master. As previously discussed, in a number of embodiments, only a single input beam angle is used to illuminate the fold master at any given time.

In addition to the discussion above, mastering systems in accordance with many embodiments of the invention can employ chirped gratings for various other purposes. Chirped gratings can aid in correcting when the incident beam on the exposure plane is not collimated and for differences between the master and the holographic waveguide being fabricated. For example, the holographic waveguide is typically inside a waveguide cell of finite thickness while the master typically has a thin protective cover applied to prevent damage to the chrome. Chirped gratings can be utilized to compensate for these additional layers. Any of a variety of protective coatings, such as glass and SiO2 protective layers, can be utilized as appropriate to the requirements of specific applications of embodiments of the invention. 3:1 dual chirped gratings provide a variety of advantages over prior art manufacturing techniques. RKVs can dramatically improve efficiency and uniformity of the holographic waveguides. RKV inputs can provide more input coupling to the waveguide, and RKV outputs can provide better pupil forming, allowing for improved brightness. As discussed above, allowing exposure of RKV input and output grating (and fold) at the same time can reduce the total manufacturing/process time. In many embodiments, both gratings share the same spacer and/or optical density between master and holographic waveguide, so the RKV profiles and the spacer windows may be configured to be balanced.

A variety of mastering systems in accordance with embodiments of the invention utilize zero order gratings. Zero order gratings can be used to control the transmittance of the zero order beam so that it would be close to the transmittance of chirped grating to allow a continuous beam ratio. This can prevent a discontinuity on the exposure (and hence diffraction efficiency in the copied grating part). In a variety of embodiments, the zero order grating does not have a diffraction order or the diffraction order does not interfere with the system. The orientation of the master and/or energy beam can be used to control the direction of the unwanted diffracting beam, but then account needs to be taken of the relative polarizations of the grating and the zero order beam. To eliminate the diffraction, in various embodiments, the period of the grating can be smaller than the limit to get evanescent diffraction wave. Using a master grating having a similar transmittance and/or period as the chirp grating at the boundary can allow for a seamless copy to be created in the liquid crystal substrate.

In many embodiments, mastering systems utilize a reference grating to align the lens position to get accurate grating period. The reference grating can help improve the 3:1 construction by allowing exposure of input, fold, and output gratings at the same time, which reduces the total manufacture time, providing high accuracy: the accuracy of the grating alignment is given by the master, which can be accurate to 0.1 nm, and a compact design, which make it attractive for larger volume manufacture. In several embodiments, the incident recording beam is collimated. To ensure that a collimated incident beam for the generation or RKV grating is being used, a reverse ray tracing can be employed by tracing the ideal construction rays from the holographic waveguide to the lens, the window thickness can be modified to change the focus of the beam relative to the hologram plane, and the lens can be shifted to achieve collimated beam output from the master to the liquid crystal substrate.

In several embodiments, mastering systems avoid undesired higher order beams being created and/or interfering with the light beam being focused on the liquid crystal substrate. In order to avoid the undesired order beam hitting the grating area, the window thickness can be adjusted, the glass can be modified, the RKV profile can be changed, the lens and/or change the incident beam angle can be changed, and/or a low refractive index material can be used to make the undesired order totally reflected by the low refractive index material.

In a number of embodiments, mastering systems utilize one or more diffraction means where the same position in the master needs to generate two different refracted beams, which is not possible unless they are different diffraction orders. To simplify the fabrication, the master is disposed in a configuration where there is no cross over of diffracted beams. In a variety of embodiments, the master is placed as close as possible to the liquid crystal substrate. In several embodiments, placing the master sufficiently far away from the cross over region can induce large separation between the 0 order and the diffracted beam. When the master is placed too far away, crossover of the diffracted beam can occur. When the master is placed too close to the substrate, undesired diffracted orders can hit the liquid crystal substrate. Therefore, mastering systems in accordance with embodiments of the invention must operate over a limited range of liquid crystal substrate to master plate separations. To increase this range, high index glass can be used to reduce the ray angle to increase the path length up to the diffracted beam cross over. Additionally, short wavelength exposure can also reduce the ray angle, which also increases the distance to cross over. In many embodiments where high index plates are used in the master stack, Fresnel reflections need to be managed, particularly for high index plates between the master and the copy plane.

Fabricating Holograms Having a Diversity of Prescriptions from a Common Master

Holographic recording systems and processes in accordance with various embodiments of the invention can be implemented to fabricate a diversity of hologram prescriptions from a common master. The exposure system can include a photosensitive material, or holographic recording material, sandwiched between two transparent substrates, the combination of which can be referred to as a copy cell. The holographic recording material can be introduced into the cell formed by the substrates using a variety of different processes including but not limited to a vacuum fill process. In some embodiments, a layer of holographic recording material is deposited onto a first substrate using an inkjet spraying process and subsequently sandwiched with a second substrate. In many embodiments, the exposure system further includes a reflector having a freeform reflective surface capable of reflecting and modifying an incident wavefront. Freeform optical surfaces can be reflective or transmissive and are usually characterized as surfaces having no translational or rotational symmetry about axes normal to the mean plane of the surface. In contrast, spherical or aspheric surfaces can be defined as surface of rotation around an optical axis. However, anamorphic surfaces, which combined spherical/aspherical and toroidal forms and therefore have translational symmetry, can also be included in the category of freeform surfaces. The chief advantage of freeform surfaces is that they can enable more sophisticated wavefront optimization in off-axis wide angle optical designs. Freeform surfaces typically cannot be manufactured using conventional two-degree-of-freedom manufacturing processing. Instead, the freeform surfaces can be manufactured using multi-degree-of-freedom processes, such as but not limited to multi-degree-of-freedom diamond cutting processes. The surface curvature of the reflector can be matched to the optical prescription of the master such that the modified wavefront's interaction with the master produces a desired exposure pattern. This scheme can be utilized to produce multiple exposure patterns, which can be employ to correct a defect in the master and/or form gratings having different characteristics than the master. During a recording operation, a light source can be configured to direct light toward the reflector, which reflects the beam. The reflected beam can have a modified wavefront, the characteristics of which can depend on the characteristics of the surface of the reflector. The modified wavefront can then interact with an exposure stack, which can be composed of the master, the copy cell, and various other layers. Upon interaction with the master, the modified beam can form an interferential pattern that exposes the copy cell, in a similar way to the processes described in the sections above.

By utilizing different reflective surfaces capable of forming different wavefronts, exposure systems in accordance with various embodiments of the invention can employ a single master grating to form different holographic gratings having a diversity of hologram prescriptions. In many embodiments, the master grating is a plane grating (i.e., a grating having planar fringes or diffracting planes), whereas the copy could contain optical power (or tilt or higher order terms). In some embodiments, a plane master could be copied to generate a copy with an optical compensation function built into the copy. Such optical compensation techniques can be utilized for various applications, such as but not limited to correcting windshield reflection aberrations in an AutoHUD waveguide. In many embodiments, such techniques can be applied to AutoHUD waveguides having large dimensions. In some embodiments, the waveguide has dimensions of at least 150 mm. by 250 mm. In further embodiments, the waveguide has dimensions of at least 300 mm. by 500 mm. As can readily be appreciated, the specific dimensions of the waveguide can depend on the specific requirements of a given application. For example, the dimensions of such AutoHUD waveguides can depend on the vehicle model in which the waveguide is intended to be implemented. The AutoHUD waveguides and other applications are described in U.S. patent application Ser. No. 16/242,979 filed on Jan. 8, 2019 entitled “Waveguide Architectures and Related Methods of Manufacturing,” the disclosure of which is hereby incorporated by reference in its entirety for all purposes.

The reconfiguration of the shape or phase of the wavefront used to illuminate the master could be achieved using various types of optical elements. In many embodiments, wavefront reconfiguration can be achieved by propagating the wavefront from the light source through a refractive element with one or more freeform surfaces. In some embodiments, a reflective or transmissive diffractive structure may be used for reconfiguring the wavefront. In several embodiments, the freeform surfaces may be dynamically reconfigurable. Many exposure systems include a wavefront sensor that can measure wavefront errors, which can be corrected using dynamically deformable freeform surfaces with the measured wavefront errors being used to calculate the deformable freeform surface prescription. In a number of embodiments, the recording system provides for compensating a second recorded grating to take into account the wavefront distortions resulting from a first recorded grating in the same holographic recording material layer.

In several embodiments, the master diffracting surface and copy cell can be separated by a spacer of a predefined thickness. The spacer can be made of any of a variety of different materials, including but not limited to glass and plastics. The specific thickness of the spacer can depend on the desired location of interaction of the exposure pattern and the contact copy plane. A contact copy plane is typically defined as a plane inside the holographic recording material layer. In some embodiments, a contact copy plane may be defined as a surface of a substrate supporting or encapsulating the holographic material recording layer. In many embodiments, the spacer thickness can be changed from one target copy to another. In some embodiments, the different layers within the exposure stack can be index-matched using an index-matching fluid or adhesive. In a number of embodiments, the master diffracting surface and the copy cell are separated by an air space. In many embodiments, the recording system provides for the fabrication of multiplexed gratings. In some embodiments, the light source is traversed such that the contact copying surface is illuminated in stages. In several embodiments, a narrow illumination patch is provided. In a number of embodiments, a broad illumination patch is provided.

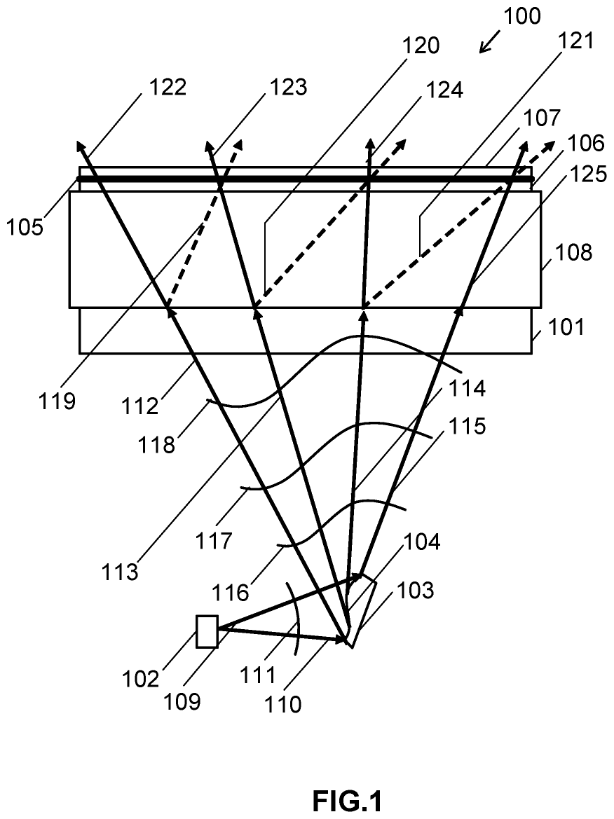

FIG. 1 conceptually illustrates a holographic recording system utilizing a reflector having a freeform reflective surface in accordance with an embodiment of the invention. As shown, the apparatus 100 for fabricating a grating includes a master grating 101, a light source 102, a reflector 103 having a freeform reflective surface 104, a layer of holographic recording material 105 sandwiched by transparent substrates 106, 107 forming a cell, which is supported by a spacer 108 that is also in contact with the master grating 101. In the illustrative embodiment, the spacer block 108 can be utilized to control the distance between the master grating 101 and the copy cell. During operation, the light source 102 emits a beam represented by edge rays 109, 110 with wavefront 111. The emitted beam may have a range of beam geometries and wavefront shapes depending on the prescription of the hologram to be recorded. After reflection at the freeform reflective surface 104, a second beam represented by rays 112-115 having a modified wavefront represented by 116-118 interacts with the master 101, which diffracts the beam into first order diffracted ray paths (such as the ones represented by rays 119-121) and zero-order non-diffracted ray paths (such as the ones represented by rays 122-125). The diffracted light can interfere with the zero-order light to form an interference pattern in the holographic recording material layer 105. Due to the modified wavefront of the reflected wave, the interference pattern can have spatial frequency characteristics that differ from those of the master grating.

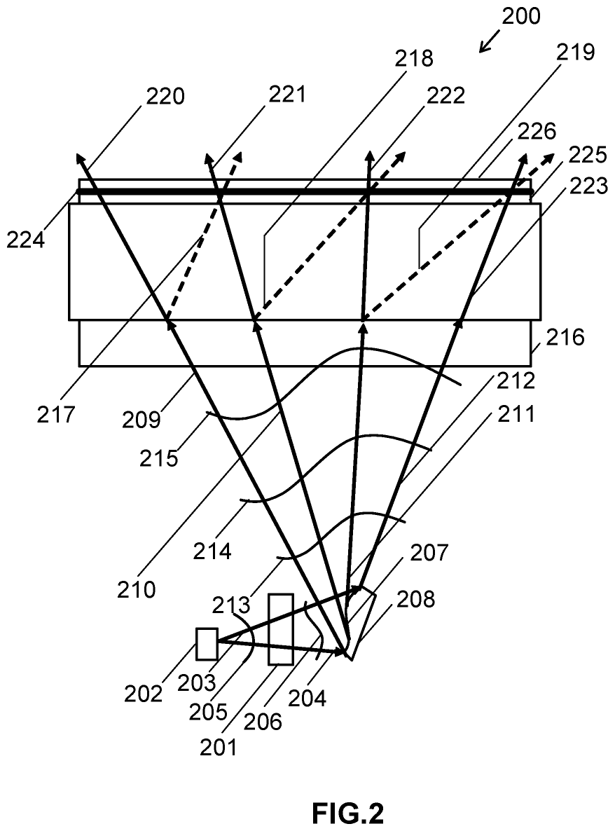

In some embodiments, such as the one shown in FIG. 2, the apparatus 200 further includes an adaptive optical element 201 in addition to other components similar to that of the embodiment illustrated in FIG. 1. In the illustrative embodiment, a light source 202 emits a beam represented by edge rays 203,204 with wavefront 205, which is changed to a modified wavefront 206 after the beam interacts with the adaptive optical element 201. After reflection at a freeform reflective surface 207 of a reflector 208, a second beam represented by rays 209-212 having a modified wavefront represented by 213-215 interacts with a master 216, which diffracts the beam into first order diffracted ray paths (such as the ones represented by the rays 217-219) and zero-order non-diffracted ray paths (such as the ones represented by the rays 220-223). Similar to the systems described above, the diffracted light interferes with the zero-order light to form a grating in a holograph recording material layer 224, which is sandwiched by two transparent substrates 225, 226. In some embodiments, the adaptive optical element provides the necessary wavefront compensation without the need for a freeform mirror. In several embodiments, the adaptive optical element is an adaptive optics mirror. In a number of embodiments, the adaptive optical element is an acoustic optical phase modulator. In some embodiments, the adaptive optical element is based on an optical array technology. As can readily be appreciated, adaptive optics can be implemented in various embodiments of the invention using any of a number of different components.

Although FIGS. 1 and 2 illustrate specific recording systems forming a holographic grating with a prescription different from the master grating, many different configurations can be used to form such holograms. Different adaptive optical elements and/or dynamically deformable freeform surfaces can be utilized. In some embodiments, different types of copy cells, such as but not limited to curved cells, can be utilized. In a number of embodiments, the system does not include a spacer. In several embodiments, the exposure stack can be index-matched using an index-matching fluid or adhesive. As can readily be appreciated, the specific configurations of such recording systems can depend on the specific requirements of a given application.

From consideration of the above embodiments, it should be apparent that by controlling the shape of the beam wavefront incident on the master, a range of copy gratings with prescriptions different from that of the master could be obtained. The practical limit on the number of prescriptions that can be produce and the grating quality can be set by factors such as the maximum period deviation from the master, the size of the copy relative to the master, the field of view, grating pitch, refractive index of the spacer, recording wavelength, separation distance of the master to copy plane, and various other factors. In some embodiments, the invention can be used to encode a windshield correction function into the copy using a plane master (or a nominal median master). This would potentially negate the need for a different master for every different AutoHUD windshield. In several embodiments, the invention could be used to correct for imperfections in a large area master generated sub-optimally as for example in the case of a nominal plane grating recorded with a two spherical beam interference pattern. The imperfect grating could then be corrected for, thereby enabling the imperfect master to be used to generate the desired wavefront result. It should also be apparent that such recording systems can be used to correct defects arising during the fabrication of the master.

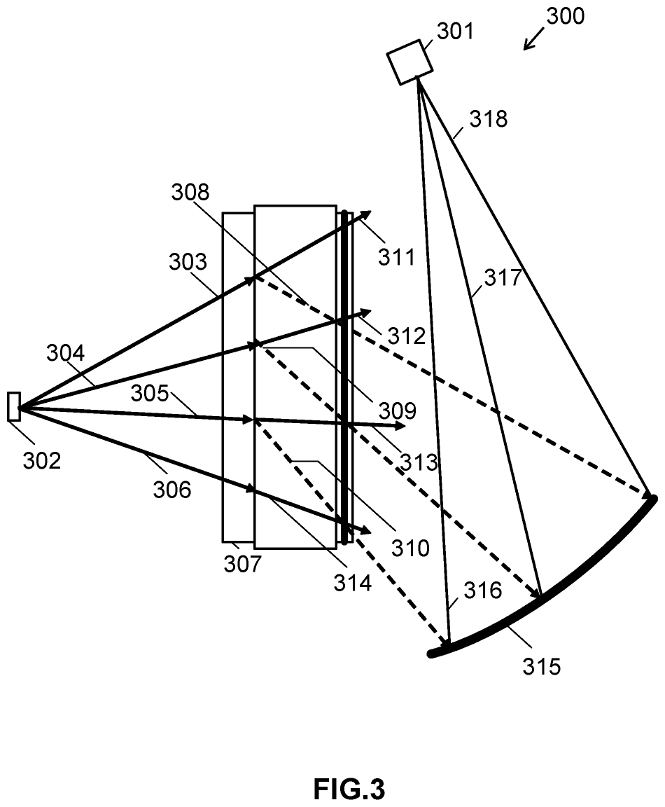

Many embodiments include at least one component for measuring and/or calibrating the wavefront formed after the beam's interaction with the master grating. Such configurations can allow for confirming that the setup meets a target copy grating prescription. FIG. 3 conceptually illustrates a recording system 300 with a wavefront sensor 301 in accordance with an embodiment of the invention. In the illustrative embodiment, the rays from the light source 302 are represented by rays 303-306. As shown, rays 303-306 interact with the master grating 307, which diffracts the beam into first order diffracted ray paths (such as the ones represented by rays 308-310). The zero-order non-diffracted ray paths in this case are represented by rays 311-314. The diffracted rays are reflected off an off-axis paraboloid surface 315 along ray paths 316-318 and focused onto the wavefront sensor 301. Various types of wavefront sensors can be utilized including but not limited to those well known to a person of ordinary skill in the art. In some embodiments, the wavefront sensor is a Shack-Hartmann sensor. In several embodiments, the wavefront sensor provides an output signal for controlling an adaptive optical element. In a number of embodiments, a wavefront sensor provides an output signal for controlling a dynamically deformable freeform surface. In such embodiments, the output signal can control the adaptive optical element or dynamically deformable freeform surface such that the changes correct any undesired characteristics found in the wavefront.

In some embodiments, the diffracted wavefront at the copy plane is focused onto a wavefront sensor. Focusing a large expanded eyebox typical of an AutoHUD into a wavefront sensor can be achieved by choosing an appropriately large collection optic such as the parabolic mirror.

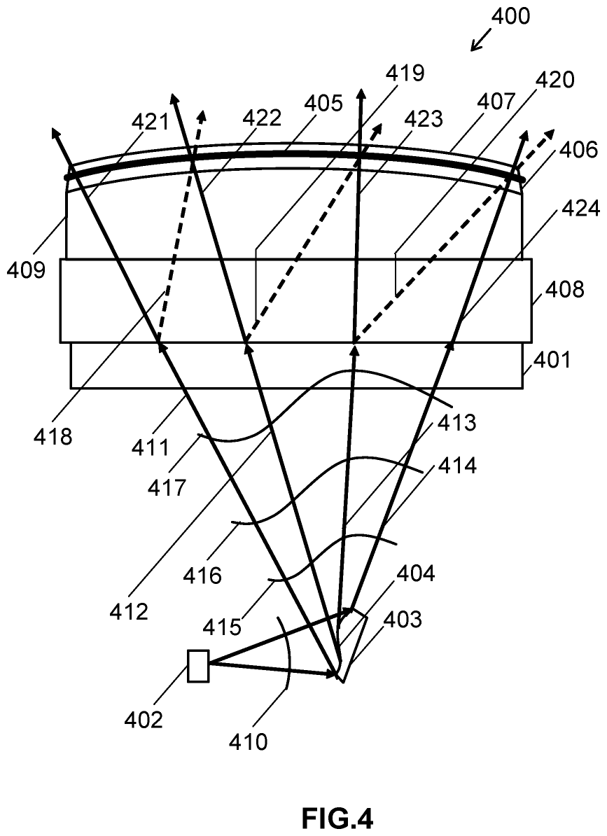

In many embodiments, there is provided a method and apparatus for recording a grating into a curved waveguide. Such waveguides can be used in head mounted display visors and/or in HUD waveguides embedded within car or aircraft windshields. FIG. 4 conceptually illustrates a recording system for recording a grating into a curved substrate in accordance with an embodiment of the invention. In the illustrative embodiment, the system 400 includes a master grating 401, a light source 402, a reflector 403 having a free form reflective surface 404, a layer of holographic recording material 405 sandwiched by curved transparent substrates 406,407 forming a curved cell. The curved cell is supported by spacers 408,409. As shown, spacer 408 is in contact with the master grating 401. During a recording operation, the light source 402 emits a beam with wavefront 410. After reflection at the freeform reflective surface 404, a second beam represented by rays 411-414 having a modified wavefront represented by 415-417 interacts with the master 401. The master grating 401 then diffracts the beam into first order diffracted ray paths (such as the ones represented by the rays 418-420) and zero-order non-diffracted ray paths (such as the ones represented by the rays 421-424). The diffracted light interferes with the zero-order light to form a grating in the holograph recording material layer 405.

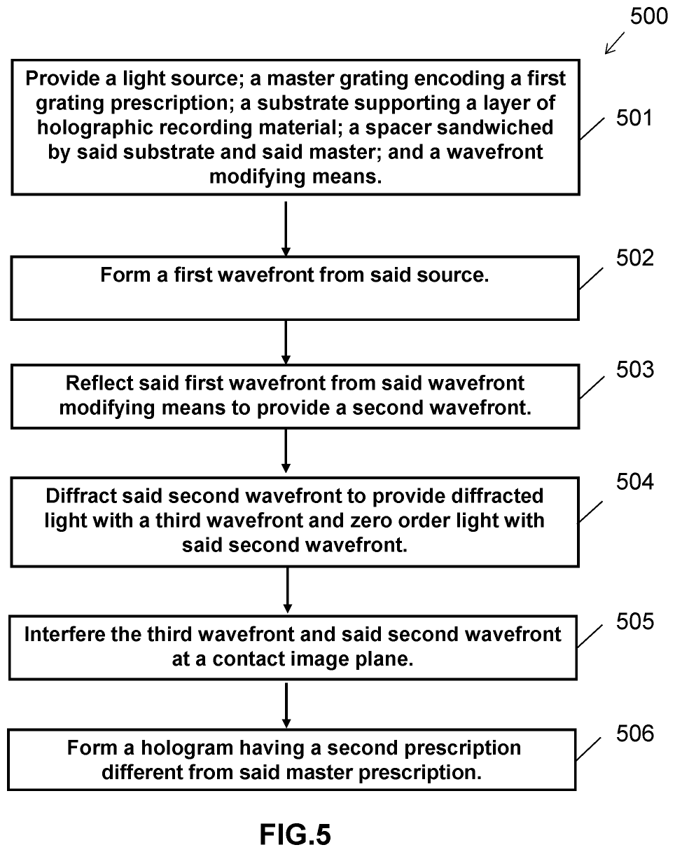

FIG. 5 is a flow chart conceptually illustrating a method of contact copying a hologram from a master in accordance with an embodiment of the invention. Referring to FIG. 5, the method 500 includes providing (501) a light source, a master grating encoding a first grating prescription, a substrate supporting a layer of holographic recording material, a spacer sandwiched by the substrate and the master, and a component for modifying a wavefront. A first wavefront can be formed (502) from the light source. The first wavefront can be reflected (503) from the component for modifying a wavefront, which forms a second wavefront. The second wavefront can be diffracted (504) to provide diffracted light with a third wavefront and zero order light with the second wavefront. The third wavefront and the zero order light can interfere (505) at the contact image plane, which can then form (506) a hologram having a second prescription different from said master prescription.

Although FIG. 5 illustrates a specific method of forming a holographic grating with a prescription different from the master grating, many different methods and processes can be used to form such holograms. In many embodiments, the method does not include the utilization of a spacer. Furthermore, different adaptive optical elements and/or dynamically deformable freeform surfaces can be utilized. In some embodiments, wavefront sensors are utilized to measure wavefronts and corrections can be made dynamically. As can readily be appreciated, the specific configurations of such recording methods can depend on the specific requirements of a given application.

### Other Embodiments

In many embodiments, the recording system is configured to fabricate a waveguide holographic grating layer that includes at least one of an input, fold, and/or output grating. In some embodiments, the system may be applied in conjunction with the fabrication processes disclosed in U.S. patent application Ser. No. 16/242,979. In some embodiments, the recording apparatus includes at least one layer for the control of at least one of polarization, wavelength, beam angle, and/or stray light. In some embodiments, the above process may further include the deposition of additional layers, such as but not limited to beam splitting coatings and environmental protection layers. In some embodiments, the substrate may be fabricated from glass. An exemplary glass substrate is standard Corning® Willow® Glass substrate (index 1.51), which is available in thicknesses down to 50 micrometers. In other embodiments, the substrate may be an optical plastic.

In some embodiments, the gratings are recorded in a holographic polymer dispersed liquid crystal (HPDLC) (e.g., a matrix of liquid crystal droplets), although SBGs may also be recorded in other materials. In a number of embodiments, SBGs are recorded in a uniform modulation material, such as POLICRYPS or POLIPHEM having a matrix of solid liquid crystals dispersed in a liquid polymer. The SBGs can be switching or nonswitching in nature. In its non-switching form an SBG has the advantage over conventional holographic photopolymer materials of being capable of providing high refractive index modulation due to its liquid crystal component. Exemplary uniform modulation liquid crystal-polymer material systems are disclosed in United State Patent Application Publication No.: US2007/0019152 by Caputo et al and PCT Application No.: PCT/EP2005/006950 by Stumpe et al., both of which are incorporated herein by reference in their entireties. Uniform modulation gratings can be characterized by high refractive index modulation (and hence high diffraction efficiency) and low scatter.

In some embodiments, at least one of the gratings is recorded a reverse mode HPDLC material. Reverse mode HPDLC differs from conventional HPDLC in that the grating is passive when no electric field is applied and becomes diffractive in the presence of an electric field. The reverse mode HPDLC may be based on any of the recipes and processes disclosed in PCT Application No.: PCT/GB2012/000680, entitled IMPROVEMENTS TO HOLOGRAPHIC POLYMER DISPERSED LIQUID CRYSTAL MATERIALS AND DEVICES. The grating may be recorded in any of the above material systems but used in a passive (non-switching) mode. The fabrication process is identical to that used for switched but with the electrode coating stage being omitted. LC polymer material systems are highly desirable in view of their high index modulation.

In some embodiments, the gratings are recorded in HPDLC but are not switched. It should be emphasized that the drawings are exemplary and that the dimensions have been exaggerated. For example, thicknesses of the SBG layers have been greatly exaggerated. Optical devices based on any of the above-described embodiments may be implemented using plastic substrates using the materials and processes disclosed in PCT Application No.: PCT/GB2012/000680, entitled IMPROVEMENTS TO HOLOGRAPHIC POLYMER DISPERSED LIQUID CRYSTAL MATERIALS AND DEVICES.

The construction and arrangement of the systems and methods as shown in the various exemplary embodiments are illustrative only. Although only a few embodiments have been described in detail in this disclosure, many modifications are possible (for example, variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

### Doctrine of Equivalents

Although specific systems and methods are discussed above, many different embodiments can be implemented in accordance with the invention. It is therefore to be understood that the present invention can be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents. Although specific embodiments have been described in detail in this disclosure, many modifications are possible (for example, variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

What is claimed is:

1. An apparatus for contact copying a hologram from a master comprising:
a light source;
a master grating;
a substrate supporting a layer of holographic recording material; and
a wavefront modifying component for modifying a wavefront from the light source disposed between the light source and the master grating.

2. The apparatus of claim 1, further comprising a transparent spacer sandwiched by the substrate and the master grating.

3. The apparatus of claim 1, wherein the wavefront modifying component comprises an element selected from the group consisting of: a reflective freeform optical surface, a transmissive freeform optical surface, a freeform optical element, an adaptive optical element, and a dynamically reconfigurable freeform optical surface.

4. The apparatus of claim 1, wherein the master grating is an amplitude grating or a volume grating.

5. The apparatus of claim 1, wherein the substrate has dimensions of at least 300 mm. by 500 mm.

6. The apparatus of claim 1, further comprising a wavefront sensor.

7. The apparatus of claim 6, wherein the wavefront sensor provides an output signal for controlling the wavefront modifying component.

8. The apparatus of claim 1, wherein the holographic recording material is a liquid crystal and monomer mixture.

9. The apparatus of claim 1, wherein the substrate is curved and the wavefront modifying component compensates for an aberration produced by optical propagation through a curved holographic waveguide.

10. The apparatus of claim 1, wherein the wavefront modifying component is configured to compensate for a defect in the master grating.

11. A method of contact copying a hologram from a master, the method comprising:
providing a light source, a master grating encoding a first grating prescription, a substrate supporting a layer of holographic recording material, and a wavefront modifying component;
forming a first wavefront from the light source;
reflecting the first wavefront from the wavefront modifying component to provide a second wavefront;
diffracting the second wavefront to provide diffracted light with a third wavefront and zero-order light with the second wavefront;
interfering the third wavefront and the zero-order light at a contact image plane; and
forming a hologram having a second grating prescription different from the first grating prescription.

12. The method of claim 11, further comprising providing a transparent spacer sandwiched by the substrate and the master grating.

13. The method of claim 11, wherein the wavefront modifying component comprises an element selected from the group consisting of: a reflective freeform optical surface, a transmissive freeform optical surface, a freeform optical element, an adaptive optical element, and a dynamically reconfigurable freeform optical surface.

14. The method of claim 11, wherein the master grating is an amplitude grating or a volume grating.

15. The method of claim 11, wherein the substrate has dimensions of at least 300 mm. by 500 mm.

16. The method of claim 11, further comprising:
providing a wavefront sensor;
measuring the third wavefront; and
providing an output signal for controlling the wavefront modifying component.

17. The method of claim 16, further comprising forming a multiplexed hologram.

18. The method of claim 11, wherein the holographic recording material is a liquid crystal and monomer mixture.

19. The method of claim 11, wherein the substrate is curved and the wavefront modifying component compensates for an aberration produced by optical propagation through a curved holographic waveguide.

20. The method of claim 11, wherein the wavefront modifying component is configured to compensate for a defect in the master grating.
